(19) United States
(12) Patent Application Publication
(10) Pub. No.: US 2005/0225058 A1
(43) Pub. Date: Oct. 13, 2005

(54) Airbag unit comprising a retaining element and supporting element for fixing the airbag

(76) Inventor: Eleonore Braun, Berlin (DE)

Correspondence Address: FOLEY AND LARDNER;SUITE 500, 3000 K STREET NW, WASHINGTON, DC, 20007, US

(21) Appl. No.: 10/510,091

(22) PCT Filed: Apr. 4, 2003
(86) PCT No.: PCT/DE03/01222

§ 371 Date: Apr. 27, 2005

(30) Foreign Application Priority Data
Apr. 5, 2002 (DE) 10216217.4

(51) Int. Cl. B60R 21/16

(52) U.S. Cl. 280/728.2

(57) ABSTRACT

The invention relates to an airbag unit comprising an airbag (3) and a flat supporting element (2), whereby the air bag (3) is situated in front of a surface (21) of the supporting element (2), and the supporting element has an opening (20) for fixing the airbag (3) thereto. The airbag unit also comprises a retaining element (1) that, for fixing the airbag (3) to the supporting element (2), interacts therewith. A section (32) of the airbag (3) passes completely through the opening (20) of the supporting element (2) to the other side of the supporting element (2) and is held there in front of the other surface (22) of the supporting element (2) by means of the retaining element (1). The dimensions both of the opening (20) of the supporting element (2) as well as of the retaining element (1) are matched to one another whereby enabling the retaining element (1) to be guided through the opening (20) in a first spatial orientation, and an edge area of the opening (20) prevents the retaining element (1) from moving in at least one second spatial orientation of the retaining element (1).

The invention relates to an airbag unit according to the precharacterizing clause of claim 1.

An airbag unit of this type is part of an airbag module which is used in motor vehicles to protect an occupant in the event of a crash. It comprises an airbag which can be inflated by means of a gas generator; a flat supporting element, in front of whose one surface the airbag is arranged and which has an opening for fixing the airbag on the supporting element; and a retaining element which interacts with the supporting element in order to fix the airbag thereon.

DE 296 06 724 discloses an airbag module for a vehicle, in which the airbag is fixed with the aid of a fastening frame, two bolts with a nut and washer and a fastening tape and is connected to a gas generator. The fastening frame is introduced into the airbag and positioned within the airbag in such a manner that, firstly, the inflow opening of the airbag and a corresponding opening of the fastening frame are arranged congruently and, secondly, two openings in each case in the airbag and fastening frame for the screw connection are arranged one above another. The fastening frame with the airbag is designed in such a manner that, after this first subassembly is connected to the gas-generator subassembly, the inflow opening of the airbag and the outflow opening of the gas generator overlap each other. The preassembled gas-generator sub-assembly is formed by putting together a gas generator, a fastening tape and a covering plate for a second outflow opening of the gas generator.

The invention is based on the problem of providing an airbag unit which can easily be installed and makes it possible with simple means to reliably fix the airbag on a supporting element of the airbag unit.

This object is achieved according to the invention by the provision of an airbag unit having the features of patent claim 1.

In accordance therewith, one section of the airbag extends through the opening of the supporting element to the other side of the supporting element and is retained there in front of the other surface of the supporting element by means of the retaining element. The dimensions of the opening of the supporting element and of the retaining element are selected in such a manner that the retaining element can be guided along a lead-through axis through the opening of the supporting element in a first spatial orientation. In a second spatial orientation, which corresponds in particular to an alignment essentially transverse with respect to the first spatial orientation, the retaining element cannot be guided through the opening of the supporting element. The edge region of the opening of the supporting element and surface elements of the retaining element then bear against one another.

In the solution according to the invention, the simple positioning and fixing of the airbag on the supporting element is of advantage. The installation is possible without additional mechanical auxiliary devices and a removal of defective components can easily be carried out.

The retaining element is preferably held within an interior space formed by the associated airbag section.

As an alternative, the retaining element can merely be clasped by the airbag section.

The supporting element and the retaining element are designed and arranged in such a manner that the retaining element reaches in a form-fitting manner behind the opening in the supporting element and that, during an airbag release in which the airbag unfolds because of the gas produced by the gas generator flowing into it, the retaining element which is clasped or held by the airbag section is pressed against the supporting element.

During the airbag release, the airbag unfolds because of the gas produced by the gas generator flowing into it, and the forces which occur in the process and act in the airbag unfolding direction partially pull the airbag section through the opening of the supporting element, in which case the retaining element, which is partially clasped or held by the airbag section, is pulled in the direction of the unfolding of the airbag. In the process, the retaining element is pressed against the edge of the opening of the supporting element because of the geometry which has been selected. The tensile forces which are produced by the unfolding of the airbag and act on the retaining element therefore brace the retaining element and the supporting element against each other, in which case further pulling of the airbag section through the opening of the supporting element is prevented by the retaining element, and the airbag is retained on the supporting element.

The retaining element is expediently designed as a small plate having such a thickness and edge length, and the opening of the supporting element is expediently of slot-shaped design with such a slot width and slot length that the thickness of the small plate is smaller than the slot width and at least one edge length of the small plate is smaller than the slot length of the supporting element. However, the retaining element and the opening of the supporting element may also be formed in accordance with other geometrical shapes.

In one preferred embodiment of the airbag unit, the retaining element is provided with a throughflow opening and the airbag is provided with an inflow opening in the region of the airbag section, said openings being arranged adjacent to the opening of the supporting element.

The airbag unit according to the invention can advantageously be used in the case of an airbag module in which a gas generator having an outflow opening is arranged in such a manner that the inflow opening of the airbag and the outflow opening of the gas generator overlap each other. During the airbag release, the gas produced by the gas generator can thus flow directly into the airbag in the region of the fastening point at which the airbag is fixed on the supporting element.

For the defined positioning of the retaining element in the airbag unit and with respect to the gas generator, a tubular, in particular cylindrical element is preferably arranged in such a manner that it protrudes through the throughflow opening of the retaining element and the opening of the supporting element. The positioning of the retaining element, of the airbag section, of the supporting element and of the gas generator with respect to one another is thereby facilitated and tilting of the retaining element is prevented. In order to conduct the gas into the airbag, the tubular element has a gas outlet in the form of a tube opening.

In one variant of the invention, the tubular element is arranged on the outflow opening of the gas generator and protrudes through the inflow opening of the airbag, the throughflow opening of the retaining element and the opening of the supporting element. The tube opening leads into the airbag in order to enable the gas to flow in during the airbag release. The risk of an escape of gas and/or of a displacement of the retaining element by the compressive forces on the retaining element that occur during the blasting of the gas into the airbag is avoided.

In a further variant, the tubular element is arranged on the throughflow opening of the retaining element and protrudes with the tube opening through the opening of the supporting element into the airbag, the throughflow opening being positioned together with the tubular element on the outflow opening of the gas generator.

Other geometrical shapes of an element for positioning the retaining element in the airbag unit and with respect to the gas generator are also conceivable. Furthermore, the element may, for example, also be of shorter design and may not protrude into the airbag.

In one embodiment, the supporting element is part of a housing which at least partially surrounds the gas generator and thereby positions the retaining element together with the airbag with respect to the gas generator. The housing and the gas generator are secured with respect to each other by screw connections. The housing may subsequently be used for fastening the airbag module in the vehicle.

In order to position and hold the airbag unit and the gas generator, a multi-part retaining device which has two hose clips may advantageously be used. The hose clips at least partially surround the gas generator and hold the supporting element, which is of essentially flat design, at a defined distance from the gas generator. Furthermore, the hose clips have apertures for holding the supporting element and are supported on the gas generator.

The hose clips are arranged on both sides of the outflow opening, along a direction of extent of the supporting element, and in each case contain an aperture for holding the supporting element, the supporting element having bending sections on its end sections. The bending sections protrude out of the apertures and are bent essentially transversely with respect to the apertures, so that the bending sections secure the supporting element on the hose clips.

Rapid and simple installation of the airbag unit and gas generator and also a low weight are advantageous in this embodiment.

One advantageous development of the invention is achieved by the retaining device having at least one fastening element which secures the gas generator on the supporting element and surrounds the gas generator in the region of the outflow openings in such a gastight manner that a chamber leading into the airbag is formed. This enables a simple installation to be associated with a saving on additional parts, with it also being possible here to dispense with lengthy alignment of the fastening element and/or of the outflow openings.

Rapid installation is also achieved by designing the fastening element as a separate part which can be connected to the supporting part, in particular by pushing on, conical pressing or screwing. Firstly, simple production of the separate part is possible. Secondly, the airbag unit can thus be adapted in a simple manner to different types of gas generator, since only the separate fastening part has to be substituted.

A bell-shaped fastening element can have a threaded attachment and a screw guided therein, the screw serving for the radial bracing of the gas generator which can be retained in the bell-shaped fastening element. The effect thus achieved is that the radial bracing also enables the retaining element and therefore also the airbag to be firmly pressed against the supporting element.

The fastening of the gas generator to the supporting element can be further simplified by means of a further, annular fastening element which is connected to the supporting element when, for fastening purposes, the gas generator can only be pushed through the annular fastening element.

In one refinement of the airbag unit, the supporting element is of multi-part design. Two parts of the supporting element are provided with cutouts which, arranged adjacent, form the opening of the supporting element, it being possible for the parts of the supporting element to have extensions which at least partially surround the gas generator.

The gas generator is advantageously of cylindrical design and has an outflow opening provided on the circumferential surface of the cylinder.

For simple orientation of the retaining element in the airbag module, a stabilizing element which is arranged between the retaining element and the gas generator and supports the retaining element on the retaining device or the housing is provided.

In order to further simplify the installation and to obtain an unambiguous alignment of the airbag, the retaining element can advantageously be fixed on the inside of the airbag. As a result, the retaining element is not able to slide to one side during the folding of the airbag and during the installation of the airbag in the housing.

In order to secure the retaining element, at least one fabric part can be fastened, in particular sewn, on the inside of the airbag. In this case, the seams are situated in the edge region in such a manner that a pocket serving to hold and fix the retaining element in place is formed between the fabric part and the airbag. A fastening may be omitted in one part of the edge region, for example a longitudinal or transverse edge, of the fabric part, thereby producing an opening in the pocket through which the retaining element can be introduced into the pocket. In one advantageous development, at least two fabric parts which have openings opening in an opposed manner are provided. When the two fabric parts are arranged one above the other or opposite each other, a secure pocket which is secured against the retaining element sliding out can thus be formed for holding the retaining element. The retaining element may also be introduced into the pocket via a slot arranged in the central region of the fabric part. The retaining element may also be secured against sliding out by means of tabs sewn transversely over the fabric part.

The invention will be explained in greater detail below with reference to the attached figures, in which:

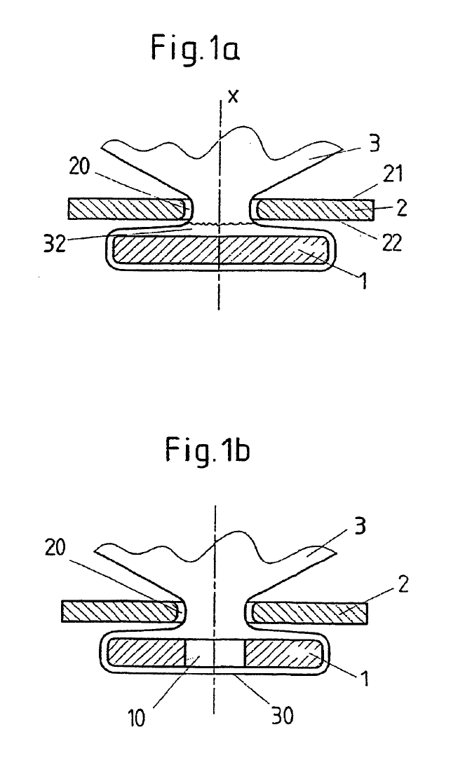

FIG. 1a shows a cross section through a cutout of an airbag unit with an airbag, a supporting element and a retaining element for fixing the airbag on the supporting element;

FIG. 1b shows a cross section according to FIG. 1a, the retaining element being provided with a throughflow opening and the airbag being provided with an inflow opening in the region of the retaining element;

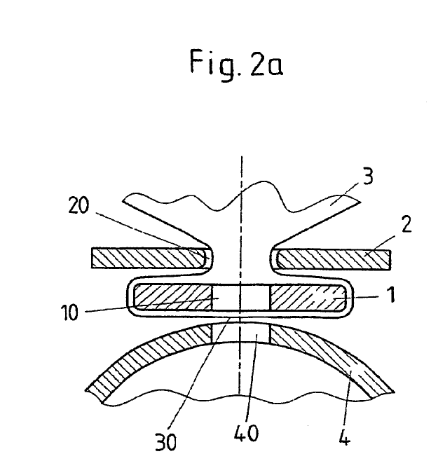

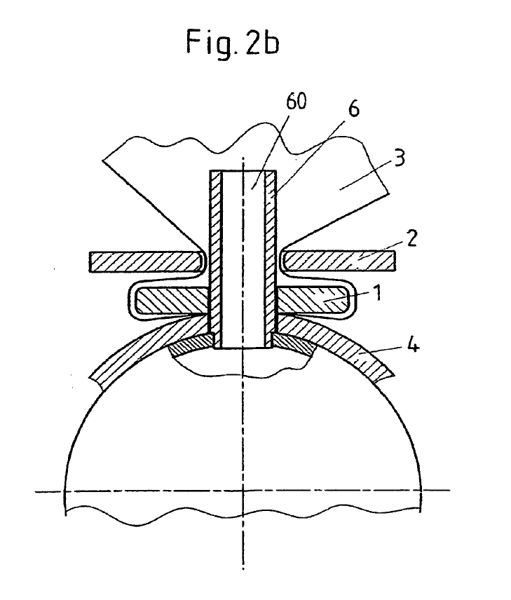

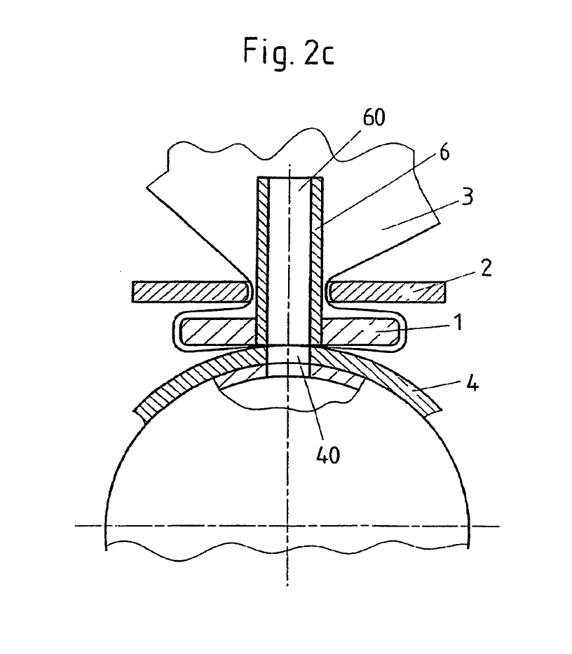

FIG. 2a shows a cross section according to FIG. 1b, a gas generator having an outflow opening also being illustrated;

FIG. 2b shows a development of the exemplary embodiment from FIG. 2a with a tubular element which is arranged on the outflow opening of the gas generator;

FIG. 2c shows a development of the exemplary embodiment from FIG. 2a with a tubular element which is arranged on the retaining element;

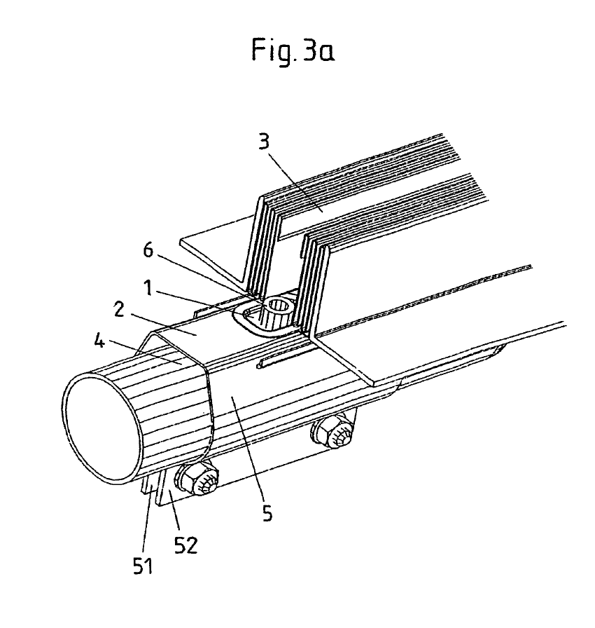

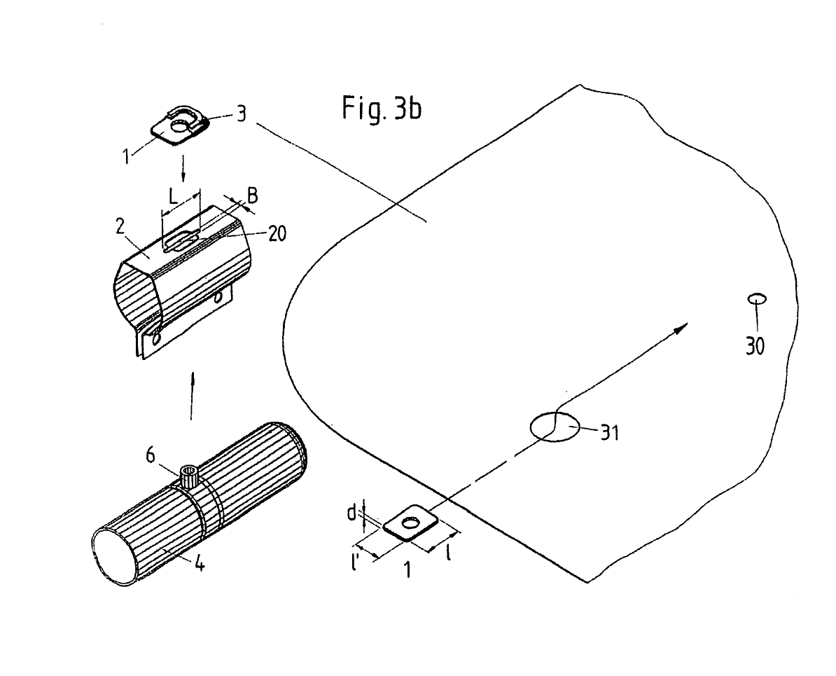

FIG. 3a shows a perspective view of an airbag unit according to FIG. 2b after installation;

FIG. 3b shows an exploded illustration of the individual parts of an airbag module according to FIG. 3a;

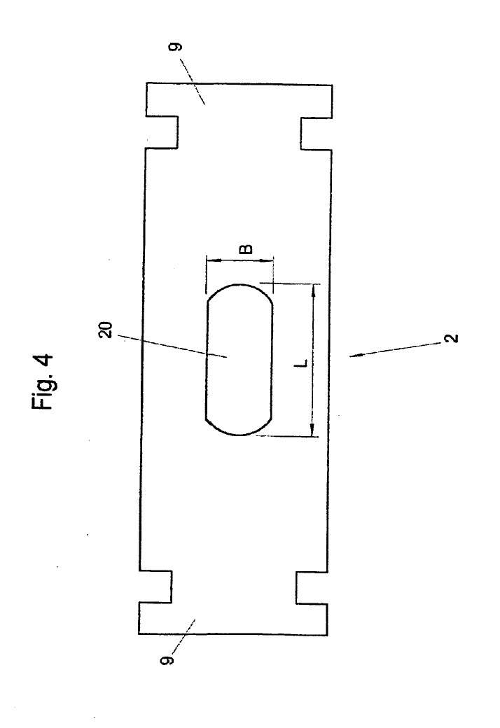

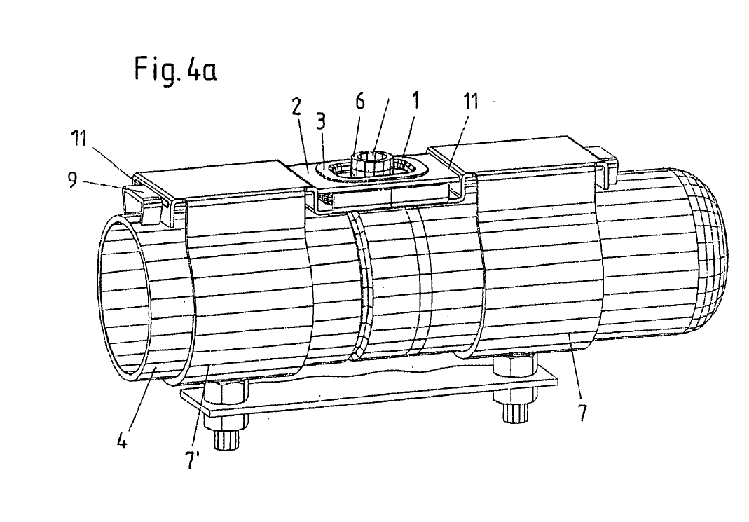

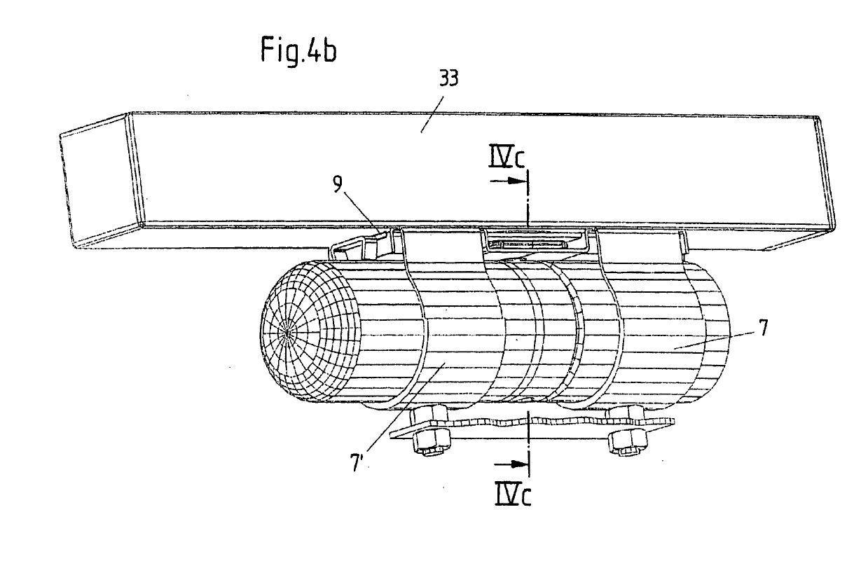

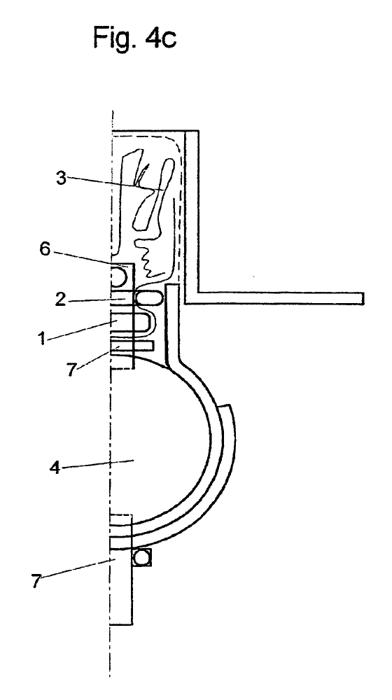

FIG. 4 shows a view of a single-part supporting element;

FIG. 4a shows a perspective view of an airbag unit with the supporting element from FIG. 4;

FIG. 4b shows a perspective view of the airbag unit from FIG. 4a containing a packed airbag;

FIG. 4c shows a cross section through the airbag unit from FIG. 4b;

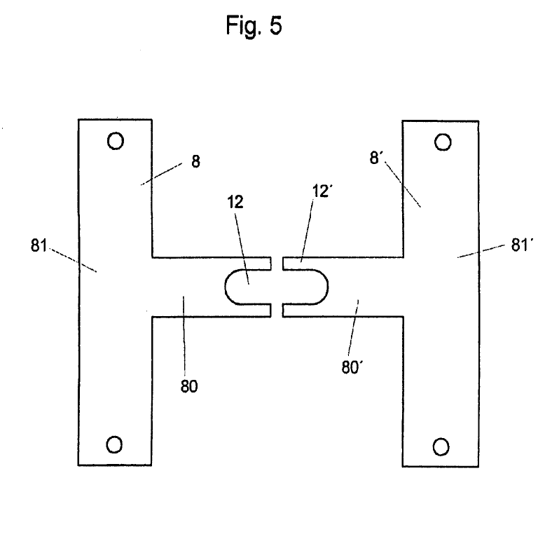

FIG. 5 shows a view of a two-part supporting element;

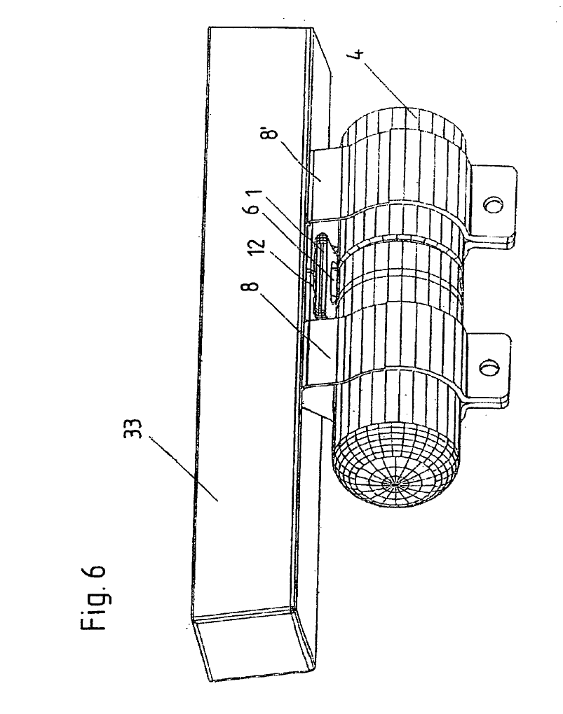

FIG. 6 shows a perspective view of an airbag unit with the supporting element from FIG. 5;

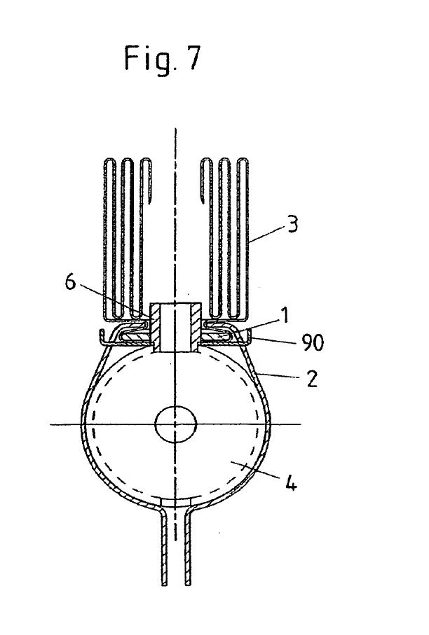

FIG. 7 shows a cross section through an airbag unit with a stabilizing element in the region of the retaining element;

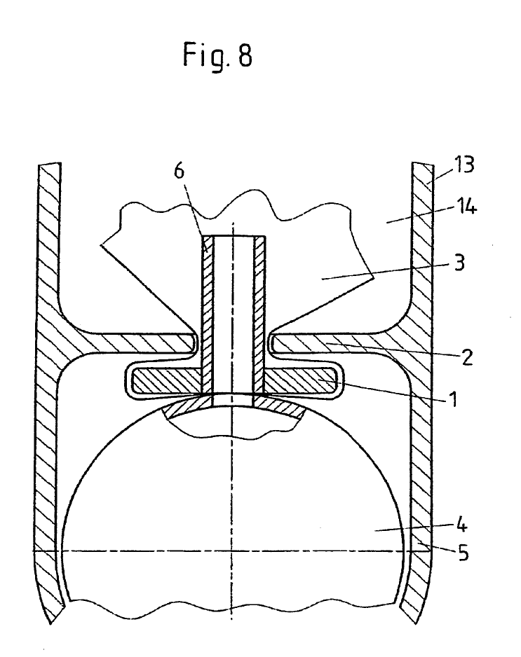

FIG. 8 shows a cross section of an airbag unit with a supporting element on which a holding device for an airbag is integrally formed;

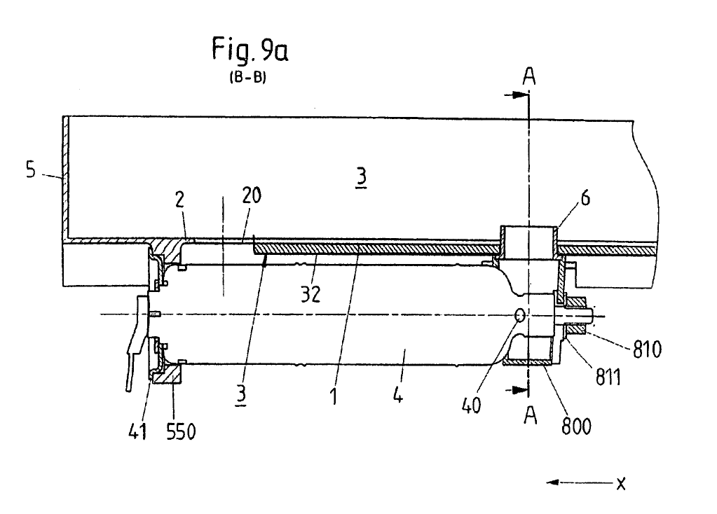

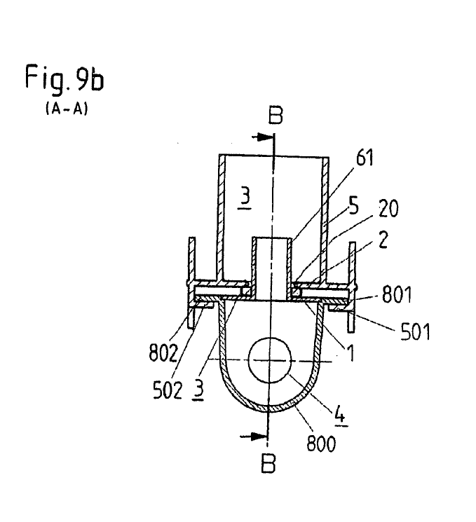

FIG. 9a shows a longitudinal section of a cutout of an airbag unit with a housing, a gas generator, a supporting element and a retaining element for fixing an airbag on the supporting element;

FIG. 9b shows a cross section through the airbag unit according to FIG. 9a,

FIG. 9c shows an exploded illustration of the individual parts of the airbag module according to FIGS. 9a and 9b;

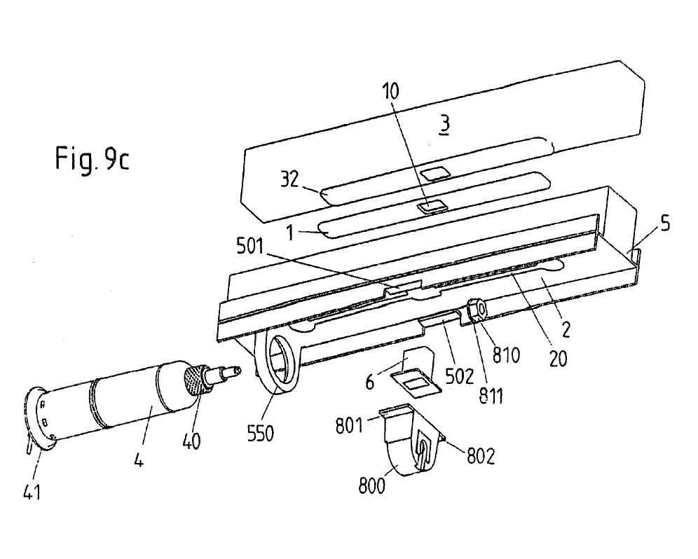

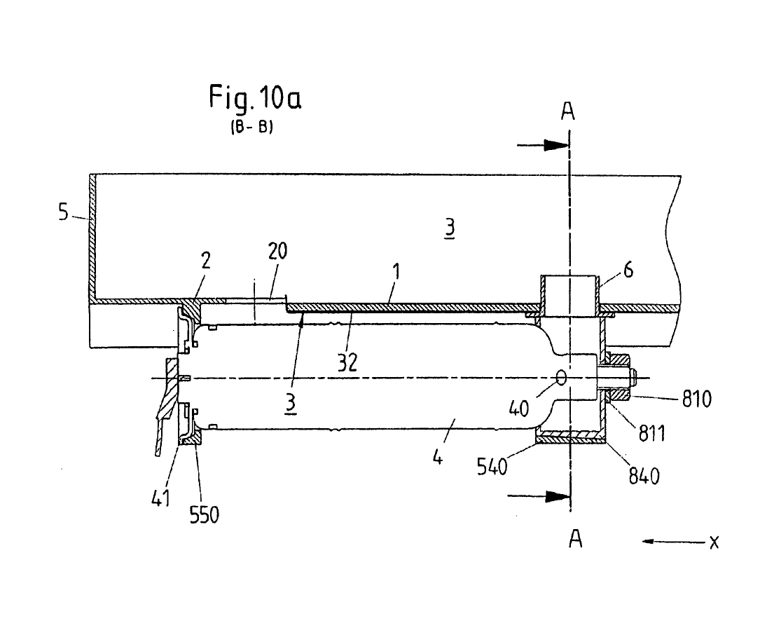

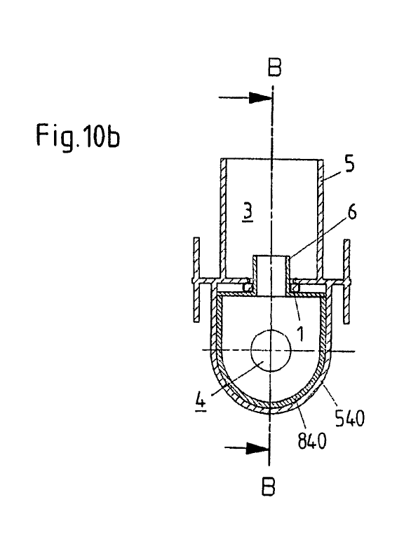

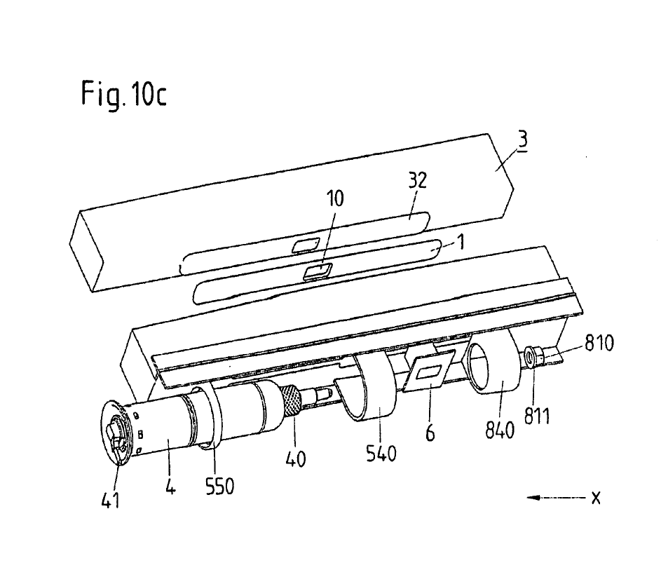

FIG. 10a shows a longitudinal section of a cutout of an airbag module in a further embodiment with a gas generator, a housing, an airbag, a supporting element and a retaining element for fixing the airbag on the supporting element;

FIG. 10b shows a cross section through the airbag module according to FIG. 10a;

FIG. 10c shows an exploded illustration of the individual parts of the airbag module according to FIGS. 10a and 10b;

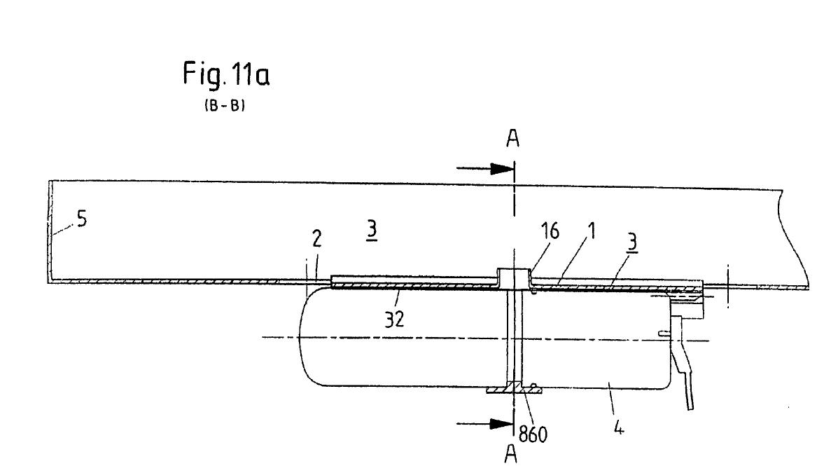

FIG. 11 shows a longitudinal section through an airbag module in a further embodiment with a housing, a supporting element, an airbag and a retaining element for fastening the airbag to the supporting element and a hose clip for fastening the gas generator to the housing;

FIG. 11b shows a cross section through the airbag module according to FIG. 11a;

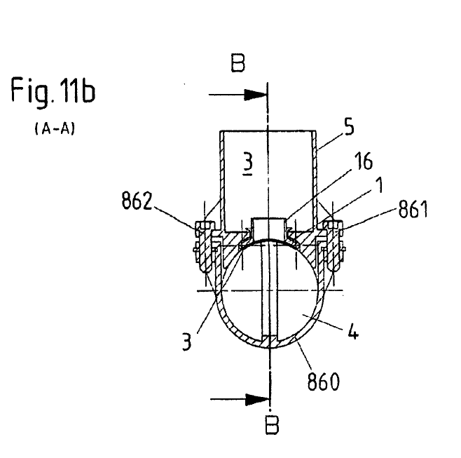

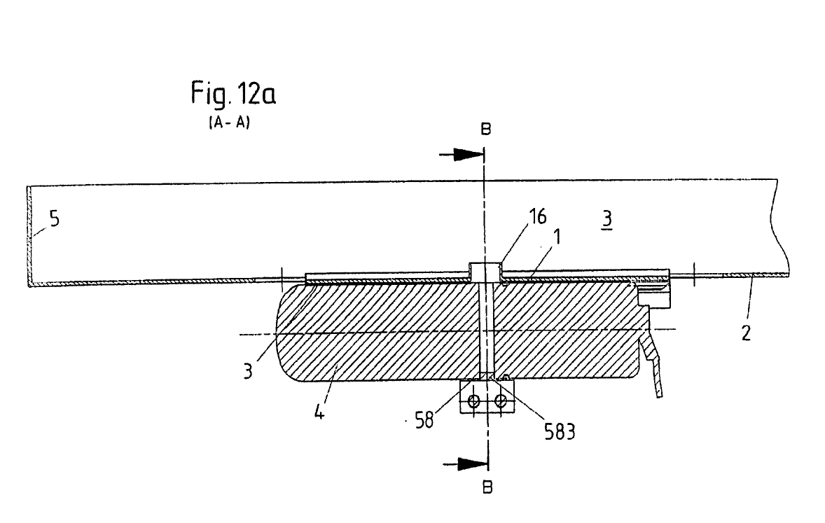

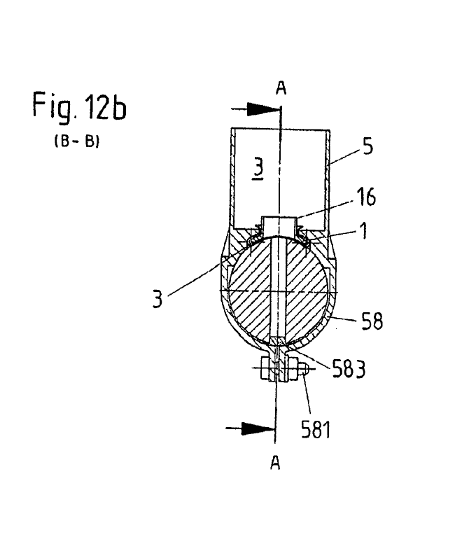

FIG. 12a shows a longitudinal section of a cutout of an airbag module in a further embodiment with a gas generator which is fastened via a hose clip formed integrally with the housing;

FIG. 12b shows a cross section through the airbag module according to FIG. 12a;

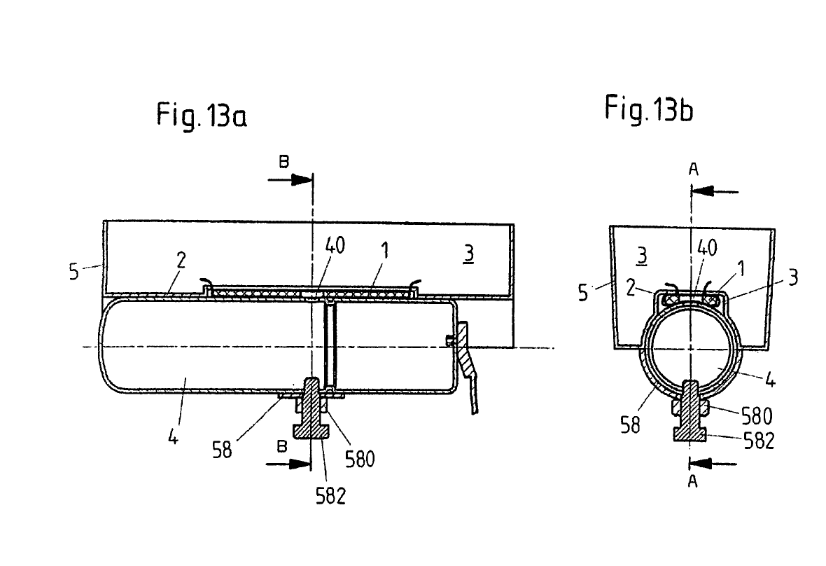

FIG. 13a shows a longitudinal section through a further airbag module with a gas generator which is braced against the supporting element via a hose clip with a threaded insert arranged on it;

FIG. 13b shows a cross section through the airbag module according to FIG. 13a;

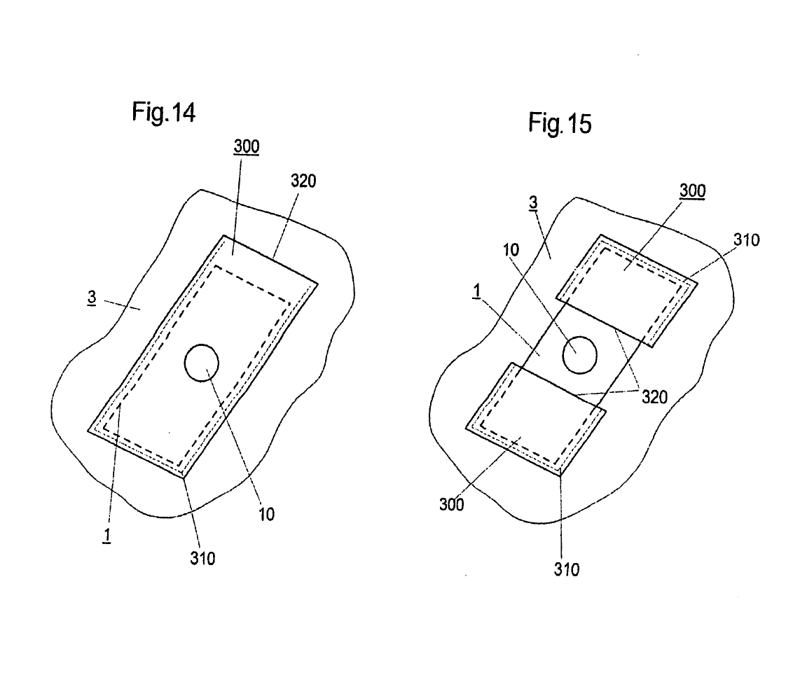

FIG. 14 shows a perspective view of the inside of an airbag, with a pocket which is fixed on the airbag and is intended for holding the retaining element, said pocket being closed on three sides and being open on one side;

FIG. 15 shows a perspective view of the inside of the airbag with two pockets for holding the retaining element;

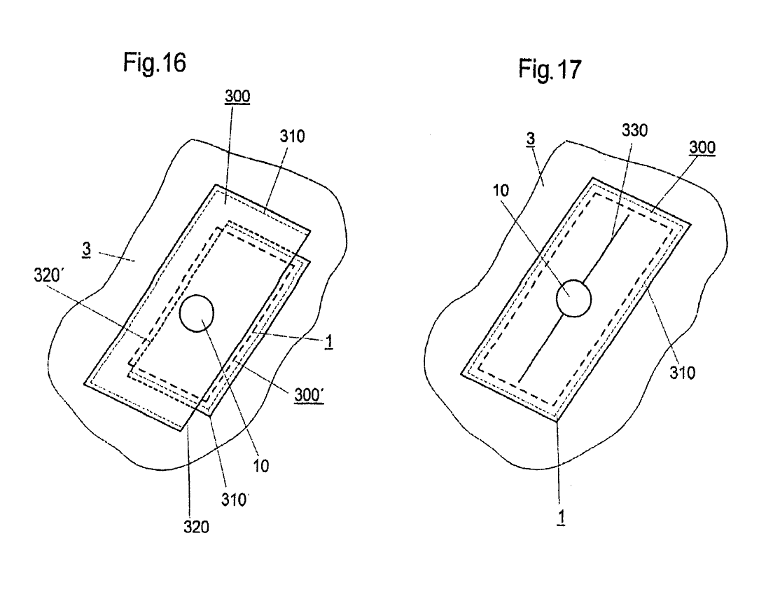

FIG. 16 shows a perspective top view of the inside of the airbag with two pockets for holding the retaining element, in a further embodiment;

FIG. 17 shows a perspective top view of the inside of the airbag with a pocket for holding the retaining element, said pocket having a cut in its central region;

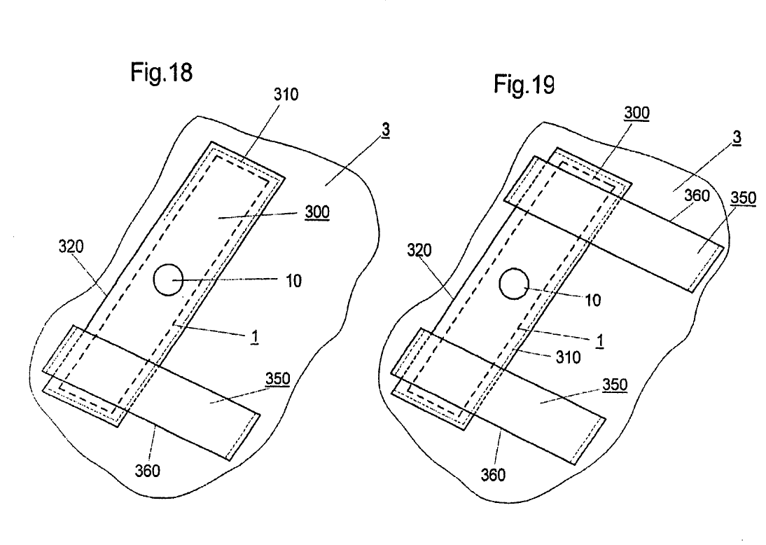

FIG. 18 shows a perspective top view of the inside of the airbag with a pocket for holding the retaining element and a tab for securing the position of the retaining element; and

FIG. 19 shows a perspective top view of the inside of the airbag with a pocket for holding the retaining element, the retaining element being secured against sliding out of the pocket by two tabs.

FIG. 1a shows a cross section through an airbag unit in the region of a supporting element 2 which has an opening 20. An airbag 3, which is indicated in the inflated state in FIG. 1a, is arranged on one side of the supporting element 2, i.e. next to one surface 21 of the supporting element 2. A section 32 of the airbag 3 is guided through the opening 20 in the supporting element 2 to the other side of the supporting element 2 and extends there next to the other surface 22 of the supporting element 2. A retaining element 1 in the form of a retaining plate is placed into this airbag section 32, said retaining element reaching behind the edge of the opening 20 in the supporting element 2 and thereby securing said airbag section 32 in a form-fitting manner against sliding through the opening 20. When the airbag 3 is inflated, the retaining element 1 is placed against the edge of the opening 20 on account of the forces acting during the inflating process, thus wedging the airbag section 32 between the retaining element 1 and the supporting element 2. As a result, the airbag 3 is secured in a form-fitting manner on the supporting element 2 in the region of the opening 20 by means of the retaining element 1.

In the exemplary embodiment according to FIGS. 1b and 2a, the retaining element 1 is additionally provided with a throughflow opening 10 and the airbag section 32, which surrounds the retaining element 1, is provided with an inflow opening 30, both the inflow opening 30 and the throughflow opening 10 being aligned with the opening 20 in the supporting element 2. Furthermore, a gas generator 4 in the form of a tubular gas generator with an outflow opening 40 arranged on the circumferential surface of its cylinder is positioned in such a manner that the outflow opening 40 of the gas generator 4, the inflow opening 30 of the airbag 30, the throughflow opening 10 of the retaining element 1 and the opening 20 of the supporting element 2 are arranged one behind another and gas emerging from the gas generator 4 can flow into the airbag 3. In this case, the retaining element 1 is positioned and held between the gas generator 4 and the supporting element 2.

In a development of the exemplary embodiment from FIGS. 1b and 2a, the cross section illustrated in FIG. 2b shows a tubular element 6 which is arranged in the outflow opening 40 of the gas generator 4 and protrudes with its gas outlet 60 through the inflow opening 30 of the airbag 3, the throughflow opening 10 of the retaining element 1 and the opening 20 in the supporting element 2 into the airbag 3. The tubular element 6 serves, on the one hand, for blasting gas into the airbag 3 and, on the other hand, for aligning the subassemblies 1, 2, 3 and 4 illustrated in FIG. 2b with respect to one another.

FIG. 2c illustrates a modification of the exemplary embodiment from FIG. 2b, in which the tubular element 6 is fixed on the retaining element 1 and is aligned with the outflow opening 40 of the gas generator 4. In this case, the retaining element 1 and the tubular element 6 may also be of single-part design, for example by the tubular element 6 being integrally formed on the retaining element 1.

FIG. 3a shows a perspective illustration of an airbag module with an airbag 3, with a gas generator 4 for inflating the airbag 3 and a retaining element 1 for fastening the airbag 3 to a supporting element 2 in an arrangement according to FIG. 2b, the supporting element 2 in the form of a supporting plate being an integral component of a housing 5 accommodating the gas generator 4.

The retaining element 1 is clasped by an airbag section 32, which protrudes through the opening 20 in the supporting element 2, to form one part and is situated on that side of the supporting element 2 which faces away from the folded airbag. The housing 5 is placed onto the gas generator 4, which is equipped with the tubular element 6, in such a manner that the tubular element 6 protrudes through the inflow opening 30 of the airbag 3, the throughflow opening 10 of the retaining element 1 and the opening 20 of the supporting element 2 into the airbag 3. On that side of the housing 5 which faces away from the supporting element 2, two radially protruding flanges 51, 52 are integrally formed on said housing and are braced against each other by means of two screw connections, with the result that the housing 5 surrounds the gas generator 4. In order to introduce the gas generator 4 into the housing 5, the latter can be expanded before the screw connections in the region of the flanges 51, 52 are tightened.

FIG. 3b shows an exploded illustration of the airbag module from FIG. 3a. For the installation of the airbag unit, the retaining element 1 is introduced into the airbag 3 through a discharge opening 31 therein, and the throughflow opening 10 of the retaining element 1 is positioned congruently with the inflow opening 30 of the airbag 3. The retaining element 1 together with the airbag section 32 surrounding it is then guided from outside the housing 5 through the opening 20 of the supporting element 2 and, on the other side of the supporting element 2, is positioned in the interior of the housing 5 in such a manner that the inflow opening 30 of the airbag 3 and the opening 20 of the supporting element 2 are aligned with the throughflow opening 10 of the retaining element 1, bringing about a flow connection. In this case, the retaining element has a thickness d and two edge lengths l, l′ and the supporting element has a slot length L and a slot width B.

For the installation of the airbag module, the housing 5 is then placed onto the gas generator 4 in such a manner that the tubular element 6 protrudes through the inflow opening 30 of the airbag 3, the throughflow opening 10 of the retaining element 1 and the opening 20 of the supporting element 2 into the airbag 3.

FIG. 4 shows an illustration of a supporting element 2 as an individual part. The supporting element 2 has as opening 20 a slot with such a width B and such a slot length L that the retaining element 1, on the one hand when aligned vertically to the supporting element 2, can be guided through the slot 20 and, on the other hand when aligned parallel to the slot 20, reaches behind the edge of the slot 20. The two lateral end sections 9 of the supporting element 2 are connected in each case via webs to the basic body of the supporting element 2 and serve as bending sections.

FIG. 4a shows the supporting element 2 from FIG. 4 as part of an airbag unit. According thereto, a retaining device comprising two hose clips 7, 7′ engages around the gas generator 4, the hose clips 7, 7′ having apertures 11 for holding the supporting element 2.

The airbag section 32 together with the retaining element 1 is guided through the opening 20 of the supporting element 2 and the supporting element 2 is placed onto the gas generator 4 in such a manner that the tubular element 6 of the gas generator 4 protrudes through the inflow opening 30 of the airbag 3 into the airbag 3. Furthermore, the supporting element 2 is positioned in such a manner that the direction of extent of the gas generator 4 and the direction of extent of the elongate supporting element 2 run along a common axis. The two hose clips 7, 7′ are placed onto the gas generator 4 in such a manner that they hold the supporting element 2 in the apertures 11 in the region of a respective connecting web, with the bending sections 9 protruding out of the apertures 11. The interlacing of the bending sections 9 enables the supporting element 2 to be secured in its position with respect to the gas generator 4.

FIG. 4b shows the perspective illustration of an airbag module according to FIG. 4a, a receptacle 33 for the folded airbag additionally being illustrated. Said receptacle situated on that side of the supporting element 2 which faces away from the gas generator 4.

FIG. 4c shows a cross section through the module from FIG. 4b. As can be seen, the retaining element 1 is surrounded by an airbag section 32 and is fixed in the vertical direction with respect to its plane of extent by the supporting element 2 and the gas generator 4 and in the horizontal direction by the tubular element 6. The tubular element 6 protrudes into the airbag 3.

FIG. 5 shows a two-part supporting element 2, comprising two T-shaped parts 8, 8′ of identical design which have a respective cutout 12 and 12′ at the free end of their central limb 80, 80′. If the two T-shaped parts 8, 8′ are joined together with their central limbs 80, 80′ abutting to form an H-shaped part, as illustrated in FIG. 5, then the two central limbs 80, 80′ form a supporting element with a slot formed by the two cutouts 12, 12′ as opening of the supporting element.

One example of an airbag unit having a supporting element 2 according to FIG. 5 is illustrated in FIG. 6. The retaining element 1 is again placed into an airbag section 32 and is placed together with the folded airbag 3, which is packed in a retainer 33, onto the tubular element 6, arranged on the outflow opening 40 of the gas generator 4, and the gas generator 4.

The two parts 8, 8′ forming the supporting element are pushed onto the gas generator 4 in the direction of extent (axial direction) of the gas generator 4 in such a manner that the cutouts 12, 12′ are positioned, as shown in FIG. 5, to result in the formation of an opening of the supporting element, through which the tubular element 6 reaches and which is arranged behind the retaining element 1.

FIG. 7 shows a section through an airbag module, in which, in a development of the preceding exemplary embodiments, a stabilizing element 90 for the positioning of the retaining element 1 is provided. The stabilizing element 90 is arranged in the airbag module in such a manner that it is positioned between the retaining element 1 (together with the airbag section 32) and the outer wall of the gas generator 4 and is supported on the supporting element 2.

FIG. 8 shows a further embodiment of an airbag module with a supporting element 2 forming part of a housing 5, the housing 5 being designed in such a manner that both the airbag 3 and the gas generator 4 are accommodated in the housing, and the supporting element 2 separates the chamber provided for holding the gas generator 4 from the storage space 14 which is provided for holding the airbag 3 and is formed by a holding device 13 of the housing 5. A tubular element 6 is designed as part of the retaining element 1 and protrudes through an opening 20 of the supporting element 2 into the airbag 3 which is arranged in the storage space 14.

FIGS. 9a, 9b and 9c show a section of an airbag module with a housing 5 and a gas generator 4. The housing 5 serves to hold the folded airbag 3. That side of the housing 5 which faces the gas generator 4 is designed as a supporting element 2 with a slot-shaped opening 20. One section 32 of the airbag 3 is fastened, in accordance with the principle described in the preceding exemplary embodiments, to the supporting element 2 with the aid of a retaining element 1. The retaining element 1 is situated on the inside of the airbag 3 and is guided in a first orientation through the slot-shaped opening 20 of the supporting element 2 and is then brought into a second orientation in such a manner that the airbag 3 is fixed on the supporting element 2.

A tubular element 6 is guided through the retaining element 1 and the airbag 3 in the region of an inflow opening of the airbag 3. The tubular element 6 may also serve at the same time as a diffuser and maintain a configuration corresponding to the desired inflow ratios.

In the embodiment shown in FIGS. 9a, 9b and 9c, the fixing of the gas generator 4 on the housing 5 is achieved via two fastening elements 550, 800. The fastening element 550 provided in the rear end of the gas generator 4, which end is opposite the outflow opening 40 of the gas generator 4, is designed as a single part with the housing 5. This fastening element 550 is designed in the form of a ring through which the tubular gas generator 4 can be guided. In this case, a stop region 41 of the gas generator 4, which region has a larger diameter than the ring, prevents the gas generator 4 from sliding out of the annular fastening element 550.

On its other side which has the outflow opening 40, the gas generator 4 is secured on the housing 5 by a further fastening element 800. In this case, the fastening element 800 is a separate part which is pushed onto the gas generator 4 in the direction X along the axis of the gas generator 4. As FIG. 9b shows, the fastening element 800 has engagement elements 801, 802 which reach under correspondingly designed retainers 501, 502 of the housing 5. When the fastening element 800 is pushed in, the engagement elements 801, 802 reach under the retainer 501, 502 and therefore fix the fastening element 800 on the housing 5. The fastening element 800 is fixed on the gas generator via a washer 811, which is deposited onto a thread of the gas generator, with a nut 810.

The gas generator 4 is therefore braced between the stop element 41, which is formed in the rear region of the gas generator 4, and the nut 810 between the two fastening elements 550, 800.

The fastening element 800 furthermore serves to conduct gas from the gas generator 4 that emerges from the outflow opening 40 into the tubular element 6. The fastening element 800 surrounds the front part of the gas generator 4 and therefore also the outflow openings 40 of the gas generator 4. This forms a closed chamber around the outflow openings 40 of the gas generator 4, said chamber leading via the tubular element 6 into the airbag 3.

FIG. 9c shows the airbag module of FIGS. 9a and 9b in an exploded illustration. The airbag 3, together with its retaining element 1 which is fixed on the inside and has a throughflow opening 10, has a shape matching the housing 5. The region 32 of the airbag 3 can be guided through the slot-shaped opening 20 of the supporting element 2 of the housing 5. In this case, the retaining element 1 is guided perpendicularly with respect to the supporting element 2 through the slot 20. The retaining element 1 is then brought into a position parallel to the supporting element 2 and the airbag 3 is therefore secured on the housing 5.

The tubular element 6 is inserted through the inflow opening 10 of the retaining element 1 and of the airbag 3. The separate fastening element 800 is subsequently brought into engagement with the lower region of the tubular element 6 in such a manner that it reaches with its protruding engagement elements 801 802 under the retainers 501, 502 of the housing 5. The gas generator is then guided through the annular fastening element 550, which is designed integrally with the housing 5, and the separate fastening element 800 until it strikes in its stop region 41 against the fastening element 550. The screw connection with the nut 810 and the washer 811 causes the separate retaining element 800 to be pressed onto the gas generator 4 in such a manner that an airtight chamber is formed around the outflow openings 40 of the gas generator 4, said chamber leading via the tubular element 6 into the airbag 3. The separate fastening element 800 is secured on the housing 5 by the engagement elements 801, 802 engaging under the retainers 501, 502.

FIGS. 10a, 10b and 10c show a further embodiment of an airbag module. A housing 5 serves again for holding an airbag 3 which is secured on the housing 5 with the aid of a retaining element 1 guided through a slot-shaped opening 20 of the supporting element 2. As already described in FIGS. 9a to 9c, a gas generator 4 is secured at its rear end via an annular fastening element 550 formed integrally with the housing 5. The fastening of the front end of the gas generator, which end has the outflow openings 40 of the gas generator 4, differs from the above-described manner.

In the region of the tubular element 6, a further, bell-shaped element 540 is formed integrally with the housing 5. A fastening element 840 can be introduced into this bell-shaped element 540, said fastening element surrounding the front region of the gas generator in such a sealing manner that again here a chamber is formed for conducting the gas flowing out of the outflow openings 40 of the gas generator 4 via the tubular element 6 into the airbag 3. The gas generator 4 is fastened with the fastening element 840 via a nut 810 and a washer 811. The fastening element 840 is of conical configuration in parts of its outer region. The bell-shaped element 540 has an opposed conicity. The introduction of the fastening element 840 in the x direction along the axis of the gas generator 4 enables the conical regions of the bell-shaped element 540 to come into engagement with the oppositely conical regions of the fastening element 840.

Owing to the conical clamping with the fastening element 840, which is secured via the screw connection, the gas generator is therefore braced between the rear bell-shaped element 550 and the front bell-shaped element 540. The gas generator 4 is therefore reliably secured on the housing 5.

FIGS. 11a and 11b show an illustration of a further airbag module. A housing 5 for holding the airbag 3 is again provided, the airbag 3 being connected to the housing 5 via a retaining part 1 secured on the supporting element 2 in the described manner. In the embodiment shown, the retaining part 1 has an integrally formed, tubular element 16 which serves to conduct a flow of gas from a gas generator 4 into the airbag 3. The integrally formed, tubular region 16 may also be designed in the form of a diffuser.

The securing of the gas generator 4 on the housing 5 takes place here via a separate hose clip 860 which is connected to the housing via screw connections 861, 862. In this case, the hose clip 860 seals off an outflow opening of the gas generator 4 that is situated at the bottom. The outflow opening of the gas generator which faces in the direction of the tubular region 16 remains free. The gases therefore emerge from the gas generator exclusively via the last-mentioned opening and pass via the tubular region 16 of the retaining element into the airbag 3.

FIGS. 12a and 12b show a further variant of the fastening principle of FIGS. 11a and 11b. An airbag 3 is again secured on the housing 5 via a retaining element 1 on the supporting element 2, which retaining element has a tubular region 16. A gas generator 4 is secured on the housing 5 via a hose clip 58 formed integrally with the housing 5. The hose clip 58 has two regions which can be expanded in relation to each other and can be braced against each other via a screw connection 581 in such a manner that the gas generator 4 is secured. This hose clip 58 also seals off only an outflow opening of the gas generator 4 that is situated at the bottom, with an additional closure stopper 583 being provided here. The route of the gases into the airbag 3 corresponds to that described in FIGS. 11a and 11b.

FIGS. 13a and 13b show a further embodiment of an airbag module, in which an airbag 3 is secured in a housing 5 in the manner already described a number of times by a retaining element 1. In this case, the housing 5 has a recess for holding the gas generator 4, said recess holding the latter up to half of its cross section. The gas generator 4 is fastened via a hose clip 58 designed as a single part with the housing 5. The hose clip 58 may also be designed as a separate component.

A threaded attachment 580 which serves to receive a threaded screw 582 is provided on the hose clip 58. The threaded screw 582 presses here against a region of the gas generator 4 and, in the process, engages in particular in an outflow opening of the gas generator 4. Engagement of the screw 582 in an outflow opening of the gas generator 4 first of all enables the gas generator to be fixed axially and the outflow opening to be closed. As in the description of FIGS. 11 and 12, only that outflow opening of the gas generator which faces in the direction of the throughflow opening of the retaining element 1 remains free. If the screw 582 is tightened, the gas generator 4 is displaced radially in the direction of the retaining element and braced against the hose clip 58. At the same time, the airbag 3 together with the retaining element 1 is thereby clamped between the gas generator 4 and the supporting element 2.

In the following FIGS. 14 to 19, various possibilities for securing the retaining element 1 on the inside of the airbag 3 are discussed. The drawings each show perspective top views of the inside of the airbag. The line which is drawn in in bold and is also dashed always represents the retaining element 1 whereas thin dashed lines represent seams.

FIG. 14 shows a fabric pocket for securing the retaining element 1 on the inside of the airbag 3. The fabric pocket has a fabric part 300 which is shown on the inside of the airbag 3 and is of somewhat larger design in its dimensions than the retaining element 1 which is to be inserted. Those edges of the fabric part 300 which protrude when the retaining element 1 is introduced are sewn to the airbag 3 on three sides by means of a seam 310. No seam is provided on one side 320 and the fabric pocket formed in this manner is open. The retaining element 1 can be introduced through this open side 320 into the fabric pocket formed in this manner.

An opening 10 for the flow of the gas from a gas generator into the airbag interior is provided in the fabric of the airbag 3 and in the fabric 300 forming the pocket and in the retaining element 1 itself.

A second embodiment for forming a fabric pocket for holding the retaining element 1 is shown in FIG. 15. Here, two fabric parts 300 are sewn onto the airbag 3 with the aid of seams 310. In this case, the seams 310 are designed in such a manner that the respectively opposite sides 320 of the fabric parts 300 do not have any seams. Two pocket-shaped regions which open towards each other are therefore produced. In the exemplary embodiment shown, the fabric parts 300 in each case cover approximately one third of the retaining element 1, so that the central third of the retaining element 1 is not covered by a fabric part.

A further embodiment is shown in FIG. 16. Two fabric parts 300 and 300′ are arranged one above the other, the upper fabric part 300 having larger edge lengths than the fabric part 300′ situated below it. The lower fabric part 300′ is sewn to the airbag 3 by three seams 310′ in such a manner that a pocket open to one longitudinal side is produced. This pocket is again dimensioned in such a manner that the retaining element 1 can be completely inserted.

The larger fabric part 300 is placed over the lower fabric part 300′ and is provided with a seam 310 in such a manner that it is likewise open on a transverse side. However, the opening of the upper pocket produced in this manner faces away from the opening of the lower pocket. The retaining element 1 inserted into the lower pocket is thus secured against sliding out.

FIG. 17 shows a further pocket which can serve for securing the retaining element 1 in the interior of the airbag 3. A fabric part 300 which has larger dimensions than the retaining part 1 is again sewn onto the airbag 3. The fabric part 300 is closed on all four sides via seams 310 and in its central region has a slot 330 which serves for the insertion of the retaining part 1 into the pocket produced in this manner.

In a further embodiment in FIG. 18, a fabric web 300, which is somewhat larger than the retaining element 1, is provided with a seam 320 on three of its sides. On the longitudinal side which is still open the seam is further continued approximately up to a third, with the result that only approx. two thirds of the length of that region of the pocket which is produced which forms the retaining part is open. As a result, the retaining part 1 can be inserted into the pocket.

In order to prevent the retaining part 1 from sliding out of the pocket which is produced, a tab 350 is provided, said tab being sewn over the pocket which is produced and being provided in the region of the pocket opening. The tab is sewn to the airbag 3 only in two regions and is open on its longitudinal sides.

FIG. 19 shows a further embodiment for securing the retaining element 1 on the airbag 3. The fabric 300 forming the pocket for holding the retaining element 1 is closed on three sides by a seam 310. Two tabs 350 are sewn transversely over the pocket. The tabs 350 are sewn to the airbag 3 only in their end regions and are accordingly open on their longitudinal sides 360. The retaining element 1 can thus be easily inserted into the pocket formed from the fabric 300 and is secured against sliding out by the tabs 350.

1. An airbag unit comprising
an airbag (3),
a flat supporting element (2), in front of whose one surface (21) the airbag (3) is arranged and which has an opening (20) for fixing the airbag (3) on the supporting element (2), and
a retaining element (1) which interacts with the supporting element (2) in order to fix the airbag (3) thereon, one section (32) of the airbag (3) extending through the opening (20) of the supporting element (2) to the other side of the supporting element (2) and being retained there in front of the other surface (22) of the supporting element (2) by means of the retaining element (1), wherein the dimensions of the opening (20) of the supporting element (2), on the one hand, and of the retaining element (1), on the other hand, are coordinated with one another in such a manner that the retaining element (1) can be guided through the opening (20) in a first spatial orientation and an edge region of the opening (20) prevents the retaining element (1) from being guided through in at least one second spatial orientation of the retaining element (1).

2. The airbag unit as claimed in claim 1, characterized in that the airbag section (32) holds the retaining element (1).

3. The airbag unit as claimed in claim 1, characterized in that the airbag section (32) is retained in a form-fitting manner on the supporting element (2) by the retaining element (1).

4. The airbag unit as claimed in claim 3, characterized in that the retaining element (1) reaches behind the edge of the opening (20) of the supporting element (2).

5. The airbag unit as claimed in in claim 1, wherein the retaining element (1) is designed as a retaining plate which, when aligned essentially parallel to the associated surface (22) of the supporting element (2), reaches behind the edge of the opening (20) of the supporting element (2) and, when aligned essentially vertically with respect to the associated surface (22) of the supporting element (2), can be guided through the opening (20) of the supporting element (2).

6. The airbag unit as claimed in claim 1, wherein the opening (20) of the supporting element has a slot of defined width (B) and slot length (L), and in that the retaining element (1) is designed as a retaining plate having such a thickness (D) and having such edge lengths (l, l′) that the thickness (d) of the retaining plate (1) is smaller than the width (B) of the slot (20) and at least one edge length (l, l′) of the retaining plate (1) is smaller than the slot length (L).

7. The airbag unit as claimed in claim 1, wherein the retaining element (1) has a throughflow opening (10) and the airbag (3) has an inflow opening (30) in the region of the airbag section (32), said openings interacting with the opening (20) of the supporting element (2) to form a passage for gas.

8. The airbag unit as claimed in claim 7, having a gas generator (4) for inflating the airbag (3), characterized in that the outflow opening (4) of the gas generator (4) and the inflow opening (30) of the airbag (3) are positioned with respect to each other in such a manner that the gas produced by the gas generator (4) can flow into the airbag (3).

9. The airbag unit as claimed in claim 7, characterized in that, in order to position the retaining element (1) with respect to the supporting element (2), a tubular element (6) is arranged in such a manner that the tubular element (6) protrudes through the throughflow opening (10) of the retaining element (1) and the opening (20) of the supporting element (2).

10. The airbag unit as claimed in claim 9, characterized in that the tubular element (6) is of hollow-cylindrical design.

11. The airbag unit as claimed in claim 9, wherein the gas generator (4) has a tubular element (6) which is arranged on the outflow opening (40) and protrudes through the inflow opening (30) of the airbag (3), the throughflow opening (10) of the retaining element (1) and the opening (20) of the supporting element (2).

12. The airbag unit as claimed in claim 11, characterized in that the retaining element (1) is provided with a tubular element (6, 16) which is arranged on the throughflow opening (10) of the retaining element (1) and is positioned with respect to the supporting element (2) in such a manner that it protrudes through the opening (20) of the supporting element (2).

13. The airbag unit as claimed in claim 12, characterized in that the retaining element (1) and the tubular element (6, 16) form a single-part or a multi-part subassembly.

14. The airbag unit as claimed in claim 8, characterized in that the supporting element (2) is part of a housing (5) which surrounds the gas generator (4) at least in some sections.

15. The airbag unit as claimed in claim 8, characterized in that a multi-part retaining device (7, 7′, 58, 540, 550, 800, 840, 860) is provided for holding the gas generator (4).

16. The airbag unit as claimed in claim 15, characterized in that the retaining device (7, 7′) retains the supporting element (2), which is of essentially flat design, at a defined distance from the gas generator (4) and surrounds the gas generator (4) at least in some sections.

17. The airbag unit as claimed in claim 15, characterized in that the retaining device (7, 7′) is formed by two hose clips (7, 7′) which have a means (11) for holding the supporting element (2).

18. The airbag unit as claimed in claim 17, characterized in that the means (11) for holding the supporting element (2) is designed as an aperture.

19. The airbag unit as claimed in claim 15, characterized in that a first hose clip (7) and a second hose clip (7′) are arranged on both sides of the outflow opening (40) of the gas generator (4), in that the hose clips (7, 7′) have two apertures (11) along the direction of extent of the supporting element (2), and in that in its end sections the supporting element (2) comprises bending sections (9) which protrude out of the apertures (11) which face away from the outflow opening, it being possible for the supporting element (2) to be fixed on the hose clips (7, 7;) by the bending sections (9) being bent transversely with respect to the direction of extent of the apertures (11).

20. The airbag unit as claimed in claim 15, characterized in that the retaining device has at least one fastening element (800, 840) which secures the gas generator on the supporting element (2) and surrounds the gas generator (4) in the region of the outflow openings (40) in such a gastight manner that a chamber leading into the airbag (3) is formed.

21. The airbag unit as claimed in claim 19, characterized in that the retaining device has at least one fastening element (860, 58) which secures the gas generator on the supporting element (2) and surrounds the gas generator (4) in the region of the outflow openings in such a gastight manner that only one outflow opening facing in the direction of a throughflow opening (10) of the retaining element (1) remains free.

22. The airbag unit as claimed in claim 20, characterized in that the fastening element (800, 840, 860) is designed as a separate part which can be connected to the supporting part (2), in particular by pushing on, conical pressing or screwing.

23. The airbag unit as claimed in claim 20, characterized in that the fastening element (58) is of bell-shaped design and has a threaded attachment (580) and a screw (582) guided therein, the screw (582) serving for the radial bracing of the gas generator (4) which can be retained in the bell-shaped fastening element (58).

24. The airbag unit as claimed in claim 20, characterized in that the fastening element (58) has at least one closure stopper (583) for sealing off an outflow opening of the gas generator (4).

25. The airbag unit as claimed in claim 20, characterized in that the retaining device has at least one further, annular fastening element (550) which is connected to the supporting element (2), which serves to hold the gas generator (4) and through which the gas generator (4) can be pushed.

26. The airbag unit as claimed in claim 1, characterized in that the supporting element (2) is of multi-part design.

27. The airbag unit as claimed in claim 26, characterized in that a first part (8) and a second part (8′) of the supporting element (2) have a respective cutout (12, 12′) and the opening (20) of the supporting element (2) is formed by the adjacent arrangement of the cutouts (12, 12′) of the two parts (8, 8′) of the supporting element (2).

28. The airbag unit as claimed in claim 26, characterized in that extensions (81, 81′) which at least partially surround the gas generator (4) are provided in each case on the two parts (8, 8′) of the supporting element (2).

29. The airbag unit as claimed in claim 8, characterized in that the gas generator (4) is designed as a tubular gas generator and the outflow opening (40) is arranged in the circumferential surface thereof.

30. The airbag unit as claimed in claim 8, characterized in that the supporting element (2) has a holding device (13) which holds the airbag (3) and forms a storage space (14) for the airbag (3).

31. The airbag unit as claimed in claim 1, characterized in that a flat stabilizing element (11) is arranged in such a manner that the retaining element (1) is supported on the supporting element (2) or on an additional retaining device (7, 7′) via the stabilizing element (90).

32. The airbag unit as claimed in claim 31, characterized in that the retaining element (1) can be fixed on the inside of the airbag (3).

33. The airbag unit as claimed in claim 32, characterized in that at least one fabric part (300, 300′) is fastened, in particular sewn, in its edge region on the inside of the airbag (3) in such a manner that the retaining element (1) can be fixed in a pocket formed between the airbag (3) and the fabric part (300, 300′).

34. The airbag unit as claimed in claim 33, characterized in that the fabric part (300, 300′) is not connected to the airbag (3) in at least part of the edge region (320, 320′), thus enabling the retaining element (1) in this part of the edge region (320, 320′) to be introduced into the pocket.

35. The airbag unit as claimed in claim 34, characterized in that two fabric parts (300, 300′) are arranged on the airbag (3) in such a manner that those parts of the edge region (320, 320′) which are not connected to the airbag (3) are arranged opposite each other in such a manner that the openings of the two pockets which are produced point in opposite directions.

36. The airbag unit as claimed in claim 35, characterized in that the two fabric parts (300, 300′) are arranged one above the other.

37. The airbag unit as claimed in claim 33, characterized in that the fabric part (300) has a slot (330) for the introduction of the retaining element (1).

38. The airbag unit as claimed in claim 34, characterized in that at least one tab (360) which is connected to the airbag (3) is guided over the fabric part (300) in such a manner that a retaining element (1) situated in the pocket is secured against sliding
